(19) United States
(12) Patent Application Publication
(10) Pub. No.: US 2026/0151999 A1
(43) Pub. Date: Jun. 4, 2026

(54) LIQUID DISCHARGE HEAD, LIQUID DISCHARGE UNIT, AND LIQUID DISCHARGE APPARATUS

(71) Applicant: Satomi ARAKI, Kanagawa (JP)

(72) Inventor: Satomi ARAKI, Kanagawa (JP)

(21) Appl. No.: 19/378,374

(22) Filed: Nov. 4, 2025

(30) Foreign Application Priority Data
Dec. 4, 2024 (JP) 2024-211135

(51) Int. Cl. B41J 2/15; B41J 2/14; B41J 2/21

(52) U.S. Cl. CPC B41J 2/15; B41J 2/14; B41J 2/2103; B41J 2002/14362

(57) ABSTRACT

A liquid discharge head includes: multiple nozzle arrays including multiple nozzles arrayed in a nozzle array direction, the multiple nozzles configured to discharge liquid, in a discharge direction orthogonal to the nozzle array direction, onto a medium conveyed in a conveyance direction orthogonal to the nozzle array direction and the discharge direction, the multiple nozzle arrays arrayed in the conveyance direction and having: end regions at both ends of the multiple nozzle arrays; and a central region between the end regions. The multiple nozzle arrays includes: upstream nozzle array on an upstream side in the conveyance direction; and downstream nozzle array on a downstream side in the conveyance direction.

### CROSS-REFERENCE TO RELATED APPLICATION

This patent application is based on and claims priority pursuant to 35 U.S.C. § 119 (a) to Japanese Patent Application No. 2024-211135, filed on Dec. 4, 2024, in the Japan Patent Office, the entire disclosure of which is hereby incorporated by reference herein.

### BACKGROUND

### Technical Field

The present disclosure relates to a liquid discharge head, a liquid discharge unit, and a liquid discharge apparatus.

### Related Art

A liquid discharge head includes multiple nozzle arrays extending in a direction (nozzle array direction) orthogonal to a discharge target medium conveyance direction, which is a direction in which a discharge target medium is conveyed, and discharges liquid from each of nozzles included in these nozzle arrays to the discharge target medium.

An airflow generated by conveyance of a discharge target medium attempts to enter a discharge region between a nozzle face of the liquid discharge head and the discharge target medium, but actually goes around to the left and right in such a way as to avoid the discharge region due to the effect of a so-called air curtain brought about by the liquid discharge in the discharge region. Due to the wraparound airflows, discharged liquid may be bent and cannot be applied to a target position (target dot position) on the discharge target medium for nozzles located near the outer periphery of the nozzle face, particularly for nozzles arranged in both end regions of a most-upstream nozzle array located on a most-upstream side in the discharge target medium conveyance direction and for nozzles arranged in both end regions of a most-downstream nozzle array located on a most-downstream side in the discharge target medium conveyance direction.

### SUMMARY

The present disclosure described herein provides a liquid discharge head including: multiple nozzle arrays including multiple nozzles arrayed in a nozzle array direction, the multiple nozzles configured to discharge liquid, in a discharge direction orthogonal to the nozzle array direction, onto a medium conveyed in a conveyance direction orthogonal to the nozzle array direction and the discharge direction, the multiple nozzle arrays arrayed in the conveyance direction and having: end regions at both ends of the multiple nozzle arrays; and a central region between the end regions. The multiple nozzle arrays includes: upstream nozzle array on an upstream side in the conveyance direction; and downstream nozzle array on a downstream side in the conveyance direction, the upstream nozzle array includes a first nozzle in one of the end regions of the upstream nozzle array in the nozzle array direction, the downstream nozzle array includes a second nozzle in one of the end regions of the downstream nozzle array in the nozzle array direction, the first nozzle is adjacent to the second nozzle in the nozzle array direction, and the first nozzle is: shifted from the second nozzle in the nozzle array direction; and disposed closer to the central region than the second nozzle in the nozzle array direction.

### BRIEF DESCRIPTIONS OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic configuration diagram illustrating an exemplary image forming system of an embodiment;

FIG. 2 is an explanatory diagram illustrating a head unit of the image forming system, viewed from a direction perpendicular to a surface of a continuous sheet facing the head unit;

FIG. 3 is an explanatory diagram illustrating an external perspective view of a liquid discharge head in the head unit;

FIG. 4 is an explanatory diagram illustrating a cross-sectional view of the liquid discharge head taken along a line orthogonal to a nozzle array direction;

FIG. 5A is an explanatory diagram for describing a configuration of nozzle arrays and wraparound airflows in a general liquid discharge head conventionally used;

FIG. 5B is an explanatory diagram illustrating dot positions on the continuous sheet, to be provided when discharge bending occurs due to the wraparound airflows;

FIG. 6A is an explanatory diagram for describing a configuration of nozzle arrays and wraparound airflows in the liquid discharge head of the embodiment;

FIG. 6B is an explanatory diagram illustrating dot positions on the continuous sheet, to be provided when discharge bending occurs due to the wraparound airflows;

FIG. 7 is an explanatory diagram illustrating an exemplary switching position located closer to one side in the nozzle array direction, a nozzle arrangement change area and a normal area being switched at the switching position;

FIG. 8 is an explanatory diagram illustrating an exemplary switching position located at a central position in the nozzle array direction, the nozzle arrangement change area and the normal area being switched at the switching position;

FIG. 9A is an explanatory diagram for describing a configuration of nozzle arrays and wraparound airflows in a liquid discharge head of a first modification;

FIG. 9B is an explanatory diagram illustrating dot positions on the continuous sheet, to be provided when discharge bending occurs due to the wraparound airflows;

FIG. 10A is an explanatory diagram for describing a configuration of nozzle arrays and wraparound airflows in a liquid discharge head of a second modification;

FIG. 10B is an explanatory diagram illustrating dot positions on the continuous sheet, to be provided when discharge bending occurs due to the wraparound airflows;

FIG. 11A is an explanatory diagram for describing a configuration of nozzle arrays and wraparound airflows in a liquid discharge head of a third modification;

FIG. 11B is an explanatory diagram illustrating dot positions on the continuous sheet, to be provided when discharge bending occurs due to the wraparound airflows;

FIG. 12 is a plan view of a part of another exemplary liquid discharge apparatus;

FIG. 13 is a side view of the part of another exemplary liquid discharge apparatus;

FIG. 14 is a plan view of a part of another exemplary liquid discharge unit;

FIG. 15 is a front view of still another exemplary liquid discharge unit; and

FIG. 16 is a schematic view of an example of an electrode manufacturing apparatus according to the embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, a description will be given of an embodiment in which a liquid discharge head according to the present embodiment is applied to an image forming system including an image forming apparatus including an inkjet printer that is a liquid discharge apparatus.

The present embodiment is not limited to a specific liquid discharge head system, and can be applied to any system such as a piezoelectric liquid discharge head, a bubble jet (registered trademark) liquid discharge head, and an electrostatic liquid discharge head.

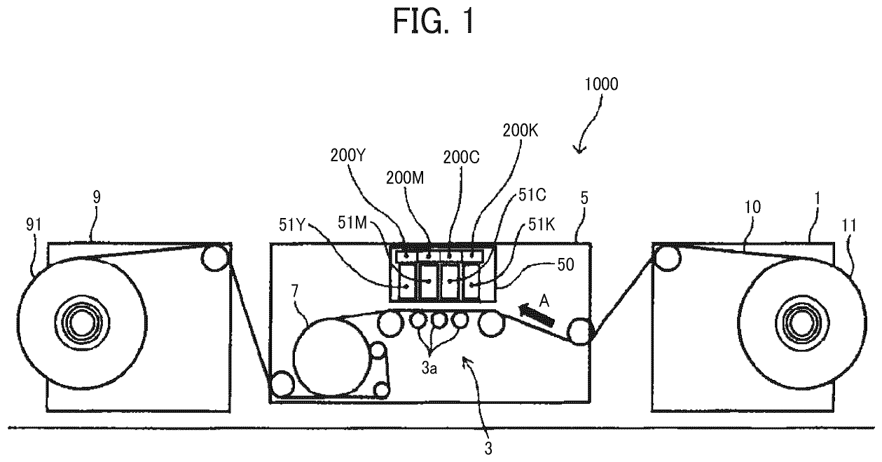

FIG. 1 is a schematic configuration diagram illustrating an exemplary image forming system 1000 of the present embodiment.

The image forming system 1000 of the present embodiment includes an unwinding device 1, an image forming apparatus 5, and a winding device 9. The unwinding device 1 conveys a continuous sheet 10 which is a continuous body as a discharge target medium. The image forming apparatus 5 discharges liquid onto the continuous sheet 10 conveyed by the unwinding device 1, to form an image. The winding device 9 delivers the continuous sheet 10 on which an image has been formed. The image forming apparatus 5 includes a conveyor 3, a dryer 7, and the like. The conveyor 3 includes conveyance rollers 3a and conveys the continuous sheet 10 conveyed by the unwinding device 1 to a head unit 50. The dryer 7 dries the continuous sheet 10 on which an image has been formed.

The continuous sheet 10 is fed out from a sheet roll 11 of the unwinding device 1, conveyed by each roller of the unwinding device 1, the conveyor 3, the dryer 7, and the winding device 9, and wound by a printing roll 91 of the winding device 9. In the image forming apparatus 5, the continuous sheet 10 is conveyed in such a way as to face the head unit 50, and an image is formed on the continuous sheet 10 by liquid for discharge use (image forming ink) discharged from the head unit 50.

In the head unit 50, for example, full-line head arrays 51K, 51C, 51M, and 51Y for four colors and liquid circulation mechanisms 200K, 200C, 200M, and 200Y corresponding to the head arrays 51K, 51C, 51M, and 51Y, respectively, are arranged in this order from an upstream side in a sheet conveyance direction (discharge target medium conveyance direction) A. The head arrays 51K, 51C, 51M, and 51Y each include one or more liquid discharge heads, and discharge liquids of black (K), cyan (C), magenta (M), and yellow (Y), respectively, to the continuous sheet 10 being conveyed.

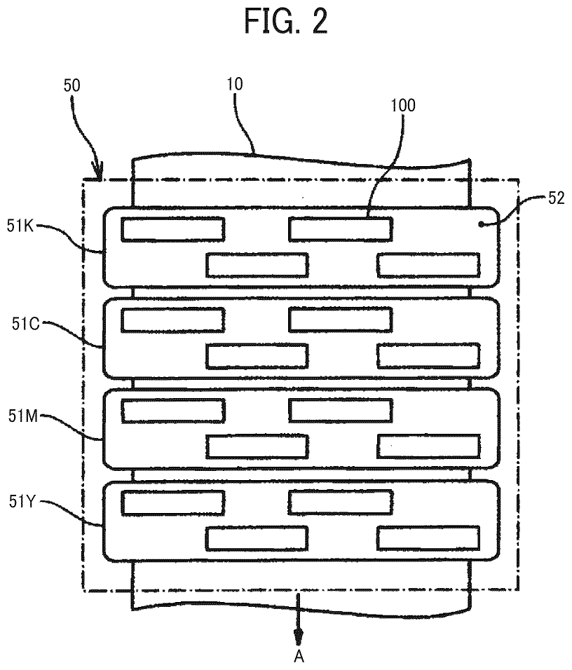

FIG. 2 is an explanatory diagram illustrating the head unit 50 viewed from a direction perpendicular to a surface of the continuous sheet 10 facing the head unit 50, so as to describe the configuration of the head unit 50.

Each of the head arrays 51K, 51C, 51M, and 51Y of the present embodiment includes liquid discharge heads 100 arranged on a base 52 in a staggered manner as illustrated in FIG. 2. Specifically, the multiple liquid discharge heads 100 are arranged in each of the head arrays 51K, 51C, 51M, and 51Y such that a nozzle array direction coincides with a sheet width direction (direction orthogonal to the sheet conveyance direction A). Positions of adjacent liquid discharge heads 100 are staggered in the sheet conveyance direction so that positions of nozzle arrays of the adjacent liquid discharge heads 100 partially overlap each other in the sheet width direction.

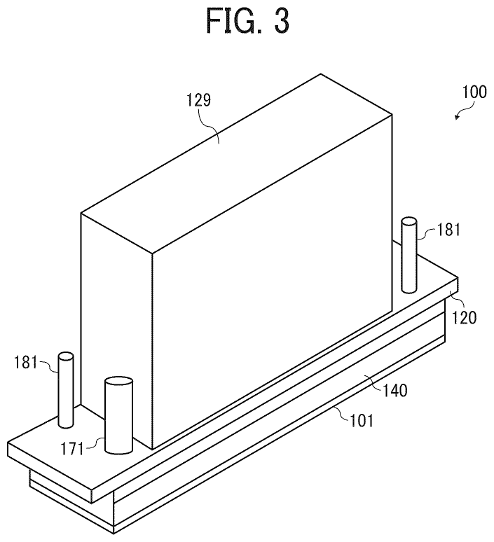

FIG. 3 is an explanatory diagram illustrating an external perspective view of the liquid discharge head 100 in the present embodiment.

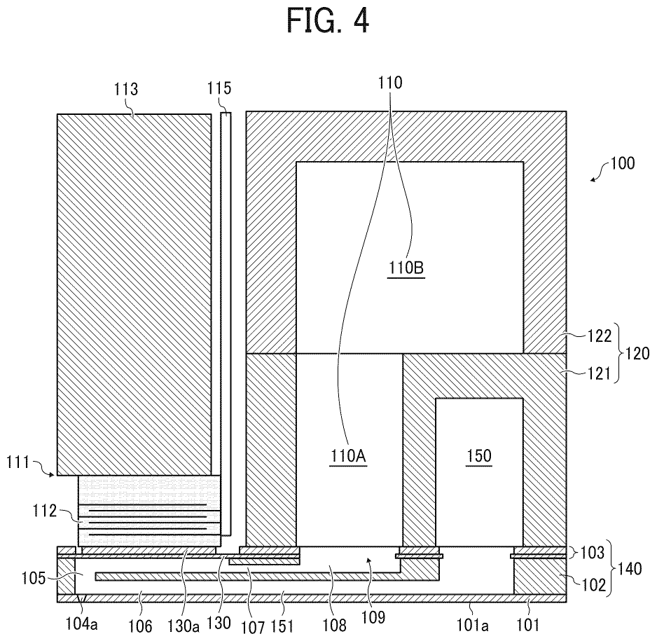

FIG. 4 is an explanatory diagram illustrating a cross-sectional view of the liquid discharge head 100 in the present embodiment, taken along a line orthogonal to the nozzle array direction.

The liquid discharge head 100 of the present embodiment includes a structural portion in which a nozzle plate 101, a channel plate 102, and a diaphragm member 103 are stacked in layers and joined together. The liquid discharge head 100 also includes a piezoelectric actuator 111, a common liquid chamber member 120, and a cover 129. The piezoelectric actuator 111 serves as a pressure generator that displaces vibration regions 130 (diaphragms) of the diaphragm member 103. The common liquid chamber member 120 also serves as a frame member of the liquid discharge head 100. A portion of the liquid discharge head 100 formed by the channel plate 102 and the diaphragm member 103 is referred to as a channel member 140.

The nozzle plate 101 has multiple nozzles 104a to discharge liquid. The liquid discharge head 100 of the present embodiment includes at least two nozzle arrays in which the multiple nozzles 104a are arranged in the nozzle array direction. An example of the liquid discharge head 100 of the present embodiment in which four nozzle arrays 104-1 to 104-4 are arranged in the sheet conveyance direction will be described below, but the number of nozzle arrays may be appropriately set.

Through-holes and grooves serving as individual liquid chambers 106, supply-side fluid resistance portions 107, and liquid inlets 108 are formed in the channel plate 102. The individual liquid chambers 106 serve as pressure chambers communicating with the nozzles 104a via nozzle communication channels 105. The supply-side fluid resistance portions 107 communicate with the individual liquid chambers 106. The liquid inlets 108 communicate with the supply-side fluid resistance portions 107. The nozzle communication channels 105 are channels that communicate with the nozzles 104a and the individual liquid chambers 106.

The liquid inlets 108 communicate with a supply-side common liquid chamber 110 through openings 109 of the diaphragm member 103.

The diaphragm member 103 includes the vibration regions 130 that are deformable and serve as a wall of the individual liquid chambers 106 of the channel plate 102. The diaphragm member 103 has, for example, a two-layer structure (not limited), and includes a first layer and a second layer arranged in this order from a side closer to the channel plate 102. The first layer forms a thin portion. The second layer forms a thick portion. The vibration region 130, which is deformable, is formed in a portion corresponding to the individual liquid chamber 106 in the first layer.

The liquid discharge head 100 includes the piezoelectric actuator 111 including an electromechanical transducer element as a driving device (actuator device or pressure generator) to deform the vibration region 130 of the diaphragm member 103. The piezoelectric actuator 111 and the individual liquid chamber 106 are disposed on opposite sides of the diaphragm member 103. For example, the piezoelectric actuator 111 includes a desired number of pillar-shaped piezoelectric elements 112 arranged at certain intervals in such a way as to form a comb shape. A piezoelectric member bonded to a base 113 is groove-processed by half cut dicing to form the piezoelectric elements 112. The piezoelectric elements 112 are joined to a protrusion 130a which is an island-shaped thick portion formed in the vibration region 130 of the diaphragm member 103. Furthermore, a flexible wiring member 115 is connected to the piezoelectric elements 112.

The supply-side common liquid chamber 110 and a delivery-side common liquid chamber 150 are formed in the common liquid chamber member 120. The supply-side common liquid chamber 110 communicates with a supply port 171, and the delivery-side common liquid chamber 150 communicates with a delivery port 181. The common liquid chamber member 120 includes, for example, a first common liquid chamber member 121 and a second common liquid chamber member 122. The first common liquid chamber member 121 is joined to the diaphragm member 103 of the channel member 140, and the second common liquid chamber member 122 is placed on and joined to the first common liquid chamber member 121 such that the first common liquid chamber member 121 and the second common liquid chamber member 122 are stacked in layers.

The first common liquid chamber member 121 defines a downstream-side common liquid chamber 110A and the delivery-side common liquid chamber 150. The downstream-side common liquid chamber 110A is a part of the supply-side common liquid chamber 110 communicating with the liquid inlets 108. The delivery-side common liquid chamber 150 communicates with delivery channels 151. The second common liquid chamber member 122 defines an upstream-side common liquid chamber 110B which is the other part of the supply-side common liquid chamber 110. The delivery channels 151 are formed in the channel plate 102. The delivery channels 151 extend along a surface direction of the channel plate 102 and communicate with the individual liquid chambers 106 via the nozzle communication channels 105. The delivery channels 151 also communicate with the delivery-side common liquid chamber 150.

In the liquid discharge head 100 according to the present embodiment, when, for example, voltage applied to the piezoelectric element 112 is lowered from a reference potential (intermediate potential), the piezoelectric element 112 contracts, and the vibration region 130 of the diaphragm member 103 is pulled. As a result, the individual liquid chamber 106 expands with an increase in volume. Thus, liquid flows into the individual liquid chamber 106. Meanwhile, when the voltage applied to the piezoelectric element 112 is increased to extend the piezoelectric element 112 in a stacking direction and to deform the vibration region 130 of the diaphragm member 103 in a direction toward the nozzle 104a, the individual liquid chamber 106 contracts with a decrease in volume. As a result, liquid in the individual liquid chamber 106 is pressurized, and the liquid is discharged from the nozzle 104a.

Liquid in the individual liquid chamber 106 that is not discharged from the nozzle 104a is delivered from the delivery channel 151 to the delivery-side common liquid chamber 150, and is supplied again from the delivery-side common liquid chamber 150 to the supply-side common liquid chamber 110 through an external circulation path. A method for driving the liquid discharge head 100 is not limited to the above-described method (i.e., pull-push discharging). A way of discharging changes depending on how a drive waveform is applied to the piezoelectric element 112. For example, pull discharging or push discharging can be performed.

Next, a description will be given of discharge bending due to wraparound airflows derived from an airflow caused by conveyance of the continuous sheet 10 in the liquid discharge head.

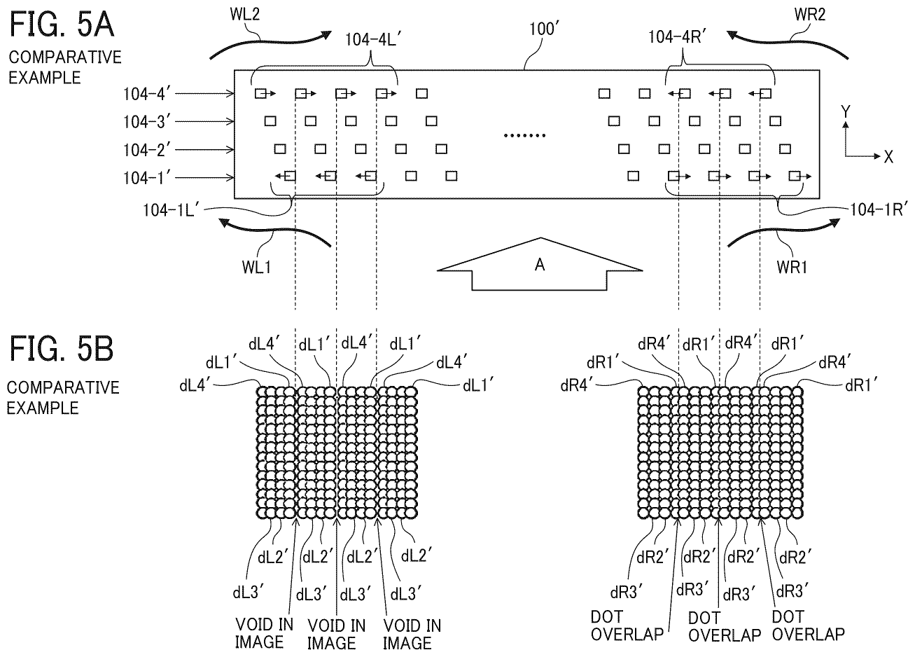

FIG. 5A is an explanatory diagram for describing a configuration of nozzle arrays and wraparound airflows in a general liquid discharge head 100′ conventionally used.

FIG. 5B is an explanatory diagram illustrating dot positions on the continuous sheet 10, to be provided when discharge bending occurs due to the wraparound airflows.

The liquid discharge head 100′ illustrated in FIG. 5A includes four nozzle arrays 104-l′ to 104-4′ extending in the nozzle array direction orthogonal to the sheet conveyance direction A. The nozzle arrays 104-1′ to 104-4′ are provided side by side in the sheet conveyance direction A. Each of the four nozzle arrays 104-1′ to 104-4′ has a configuration in which the multiple nozzles 104a are arranged at the same nozzle pitch, and respective positions of corresponding nozzles 104a of the nozzle arrays are each shifted in the nozzle array direction by one dot in order from a nozzle array on the upstream side to a nozzle array on a downstream side in the sheet conveyance direction A. As a result, a dot pitch in the sheet width direction (the interval between positions (dots) where liquid is to be applied to the continuous sheet 10 in the nozzle array direction) to be formed on the continuous sheet 10 by the liquid discharge head 100′ can be made narrower than the nozzle pitch, and the density of dots can be increased.

Specifically, on the continuous sheet 10, dots dL2′ and dR2′ of liquid discharged from the nozzles 104a of a second nozzle array 104-2′ located second from the upstream side in the sheet conveyance direction A are formed adjacent (adjacent in the nozzle array direction, the same applies to the following) to dots dL1′ and dR1′ of liquid discharged from the nozzles 104a of a first nozzle array 104-1′, which is the most-upstream nozzle array located most upstream in the sheet conveyance direction A, as illustrated in FIG. 5B. Next, dots dL3′ and dR3′ of liquid discharged from the nozzles 104a of a third nozzle array 104-3′ located third from the upstream side in the sheet conveyance direction A are formed adjacent to the dots dL2′ and dR2′. In addition, dots dL4′ and dR4′ of liquid discharged from the nozzles 104a of a fourth nozzle array 104-4′, which is the most-downstream nozzle array located most downstream in the sheet conveyance direction A, are formed adjacent to the dots dL3′ and dR3′. Then, the dots dL1′ and dR1′ of the liquid discharged from the nozzles 104a of the first nozzle array 104-1′, which is the most-upstream nozzle array, are formed again adjacent to the dots dL4′ and dR4′, and the process is repeated thereafter.

As a result, in the liquid discharge head 100′, nozzles 104-1R′ and 104-1L′ arranged in both end regions of the first nozzle array 104-1′, which is the most-upstream nozzle array, and nozzles 104-4R′ and 104-4L′ arranged in both end regions of the fourth nozzle array 104-4′, which is the most-downstream nozzle array, correspond to the dots dL1′, dL4′, dR1′, and dR4′ adjacent to each other on the continuous sheet 10, as illustrated in FIG. 5B.

In the liquid discharge head 100′, when discharged liquid is not bent by wraparound airflows WR and WL, a dot pitch for dots formed by liquid discharged from the nozzles of the first nozzle array 104-1′ and the nozzles of the fourth nozzle array 104-4′ becomes a target pitch. However, when an airflow is generated by conveyance of the continuous sheet 10, the airflow goes around to the left and right of the nozzle face (outer sides of the nozzle face in the nozzle array direction) due to the effect of an air curtain brought about by liquid discharge in the discharge region. Then, due to wraparound airflows WR1 and WL1, liquid discharged from each of the nozzles 104-1R′ and 104-1L′ arranged in opposite end regions of the first nozzle array 104-1′ located most upstream in the sheet conveyance direction A is bent from a center toward a corresponding end in the nozzle array direction as indicated by an arrow in FIG. 5A.

As illustrated in FIG. 5A, wraparound airflows WR2 and WL2 after wrapping around the outer sides of the nozzle face in the nozzle array direction flow in such a way as to enter the downstream side of the nozzle face in the sheet conveyance direction. Therefore, liquid discharged from each of the nozzles 104-4R′ and 104-4L′ arranged in opposite end regions of the fourth nozzle array 104-4′ located at the most downstream in the sheet conveyance direction A is bent by the wraparound airflows WR2 and WL2 from a corresponding end toward the center in the nozzle array direction as indicated by arrows in FIG. 5A.

As described above, in the liquid discharge head 100′, liquid discharged from the nozzles 104-1R′ and 104-1L′ arranged in both the end regions of the first nozzle array 104-1′ is bent by the wraparound airflows WR and WL (WR1 and WL1) in a direction opposite to a direction in which liquid discharged from the nozzles 104-4R′ and 104-4L′ arranged in both the end regions of the fourth nozzle array 104-4′ is bent by the wraparound airflows WR and WL (WR2 and WL2).

An example in which the first nozzle array 104-1′ located most upstream in the sheet conveyance direction A and the fourth nozzle array 104-4′ located most downstream, which are greatly affected by discharge bending due to wraparound airflows, correspond to dots adjacent to each other on the continuous sheet 10, has been described here, but the present disclosure is not limited thereto. For example, as in the first nozzle array 104-1′, discharge bending due to wraparound airflows may also occur in the second nozzle array 104-2′, which is a nozzle array located second from the upstream side in the sheet conveyance direction A, although the second nozzle array 104-2′ is not affected much by the discharge bending. Furthermore, for example, as in the fourth nozzle array 104-4′, discharge bending due to wraparound airflows may also occur in the third nozzle array 104-3′, which is a nozzle array located second from the downstream side in the sheet conveyance direction A, although the third nozzle array 104-3′ is not affected much by the discharge bending. Thus, the same applies to a case where either of the first nozzle array 104-1′ and the second nozzle array 104-2′ located on the upstream side in the sheet conveyance direction A and either of the fourth nozzle array 104-4′ and the third nozzle array 104-3′ located on the downstream side in the sheet conveyance direction A correspond to dots adjacent to each other on the continuous sheet 10.

Here, when discharge bending due to the wraparound airflows WR and WL occurs in the liquid discharge head 100′ described above, dot positions (positions where discharged liquid is to be applied) on the continuous sheet 10 are displaced, and image quality may be significantly deteriorated.

Specifically, as in the end region on the right side of FIG. 5B, when discharged liquid is bent by the wraparound airflows WR and WL in a direction in which the dots dR1′ and dR4′ approach each other between the first nozzle array 104-1′ and the fourth nozzle array 104-4′, image quality degradation may occur in which image density becomes higher than desired density due to overlapping of adjacent dots.

In contrast, when discharged liquid is bent by the wraparound airflows WR and WL in a direction in which the dots dL1′ and dL4′ are separated from each other between the first nozzle array 104-1′ and the fourth nozzle array 104-4′ as in the end region on the left side of FIG. 5B, image quality degradation may occur in which dot vacancy (void in the image) is caused by separation of adjacent dots.

Among these types of image quality degradation (dot overlap, void in the image), the former (dot overlap) is a minor image quality degradation that barely matters, but the latter (void in the image) is a major problem that needs to be eliminated, and is significant image quality degradation. Then, in the general liquid discharge head 100′ as illustrated in FIGS. 5A and 5B, a void in the image (dot vacancy), which is significant image quality degradation, is caused by the wraparound airflows WR and WL in either one of both end regions (the end region on the left side in FIG. 5B).

Furthermore, in the present embodiment, multiple liquid discharge heads are arranged side by side to form the full-line head unit 50. In such a configuration, when the liquid discharge heads 100′, in which image quality degradation due to a dot overlap occurs in one end region and image quality degradation due to a void in the image occurs in the other end region, are arranged, an image portion where a dot overlap occurs (a portion where the image is dark) and an image portion where a void in the image occurs are adjacent to each other at a joint portion between the multiple liquid discharge heads 100′, as described above. In such a case, the image quality degradation due to a void in the image is easily noticeable due to density contrast, and becomes more significant image quality degradation.

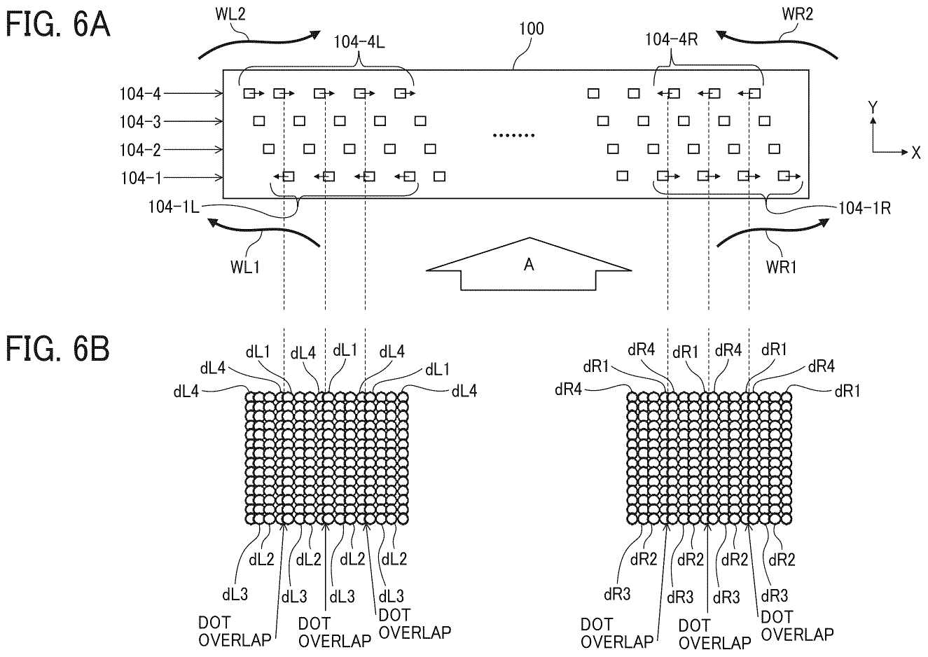

FIG. 6A is an explanatory diagram for describing a configuration of nozzle arrays and wraparound airflows in the liquid discharge head 100 of the present embodiment.

FIG. 6B is an explanatory diagram illustrating dot positions on the continuous sheet 10, to be provided when discharge bending occurs due to the wraparound airflows.

As illustrated in FIG. 6A, the liquid discharge head 100 of the present embodiment is configured such that, in either one of both end regions, dots dL1 and dR1 corresponding to the nozzles 104-1L and 104-1R of the first nozzle array 104-1 are adjacent to dots dL4 and dR4 corresponding to the nozzles 104-4L and 104-4R of the fourth nozzle array 104-4 such that the dots dL1 and dR1 are located closer to a nozzle array direction central region than the dots dL4 and dR4. In other words, with respect to the nozzle arrangement in the end region on the left side of FIG. 5B in the liquid discharge head 100′ illustrated in FIGS. 5A and 5B, positions of the nozzle 104-1L′ of the first nozzle array 104-1′ and the nozzle 104-4L′ of the fourth nozzle array 104-4′ are interchanged in the nozzle array direction.

With this configuration, discharged liquid is bent by the wraparound airflows WR and WL in a direction in which the dots dL1, dR1, dL4, and dR4 approach each other between the first nozzle array 104-1 and the fourth nozzle array 104-4 in either end region in the present embodiment, as indicated by arrows in FIG. 6A. Therefore, in either end region, there is no significant image quality degradation of a void in the image (dot vacancy) caused by the bending of liquid in a direction in which the dots are separated from each other between the first nozzle array 104-1 and the fourth nozzle array 104-4.

In the present embodiment, when the wraparound airflows WR and WL are generated, image quality degradation of a dot overlap due to discharge bending may occur in both end regions. However, the image quality degradation of a dot overlap is minor image quality degradation as described above, and barely matters.

As described above, in the present embodiment, even when the wraparound airflows WR and WL are generated, the significant image quality degradation of a void in the image does not occur. Therefore, it is not necessary to adopt a configuration (configuration in which a nozzle pitch is changed from an original nozzle pitch in advance by an amount by which liquid is to be bent by wraparound airflows) similar to the configuration of the liquid discharge head disclosed in, for example, Japanese Unexamined Patent Application Publication No. 2019-181765. Thus, in the liquid discharge head 100 of the present embodiment, the nozzles are arranged in all the nozzle arrays 104-1 to 104-4 such that there is no displacement of dot positions in a situation where the wraparound airflows WR and WL are not generated. As a result, in a situation where the wraparound airflows WR and WL are not generated, it is possible to perform high-quality liquid discharge with no or little displacement of dot positions. Then, even in a situation where the wraparound airflows are generated, the significant image quality degradation of a void in the image does not occur as described above, so that liquid discharge can be performed with constant quality.

In particular, in the present embodiment, even when multiple liquid discharge heads are arranged to form the full-line head unit 50, it is possible to eliminate the image quality degradation of a void in the image that is noticeable at a joint portion between the multiple liquid discharge heads.

According to the present embodiment, image quality degradation that can occur in either end region is the image quality degradation of a dot overlap. Therefore, even if the multiple liquid discharge heads 100 are arranged to form the full-line head unit 50, image portions (portions where the image is dark) in which a dot overlap occurs are adjacent to each other at a joint portion between the multiple liquid discharge heads 100. Therefore, since density contrast is small, the image quality degradation of a dot overlap is less noticeable.

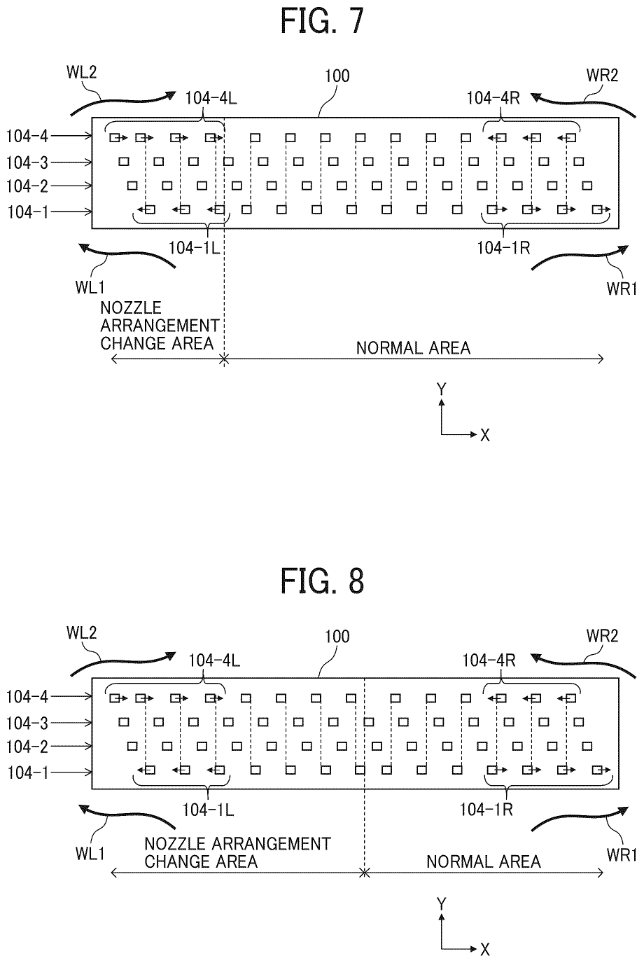

As illustrated in FIG. 7, a switching position where an area (nozzle arrangement change area) of the positional relationship (dot positional relationship) between the nozzles 104-1L of the first nozzle array 104-1 and the nozzles 104-4L of the fourth nozzle array 104-4 in the end region on the left side of FIG. 6A and an area (normal area) of the positional relationship (dot positional relationship) between the nozzles 104-1R of the first nozzle array 104-1 and the nozzles 104-4R of the fourth nozzle array 104-4 in the end region on the right side of FIG. 6A are switched may be located closer to either one of end sides in the nozzle array direction (closer to the left in the example of FIG. 7). As illustrated in FIG. 8, the switching position between the nozzle arrangement change area and the normal area may be a central position in the nozzle array direction.

### First Modification

Next, a description will be given of a modification (the present modification is hereinafter referred to as a “first modification”) of the liquid discharge head according to the above-described embodiment.

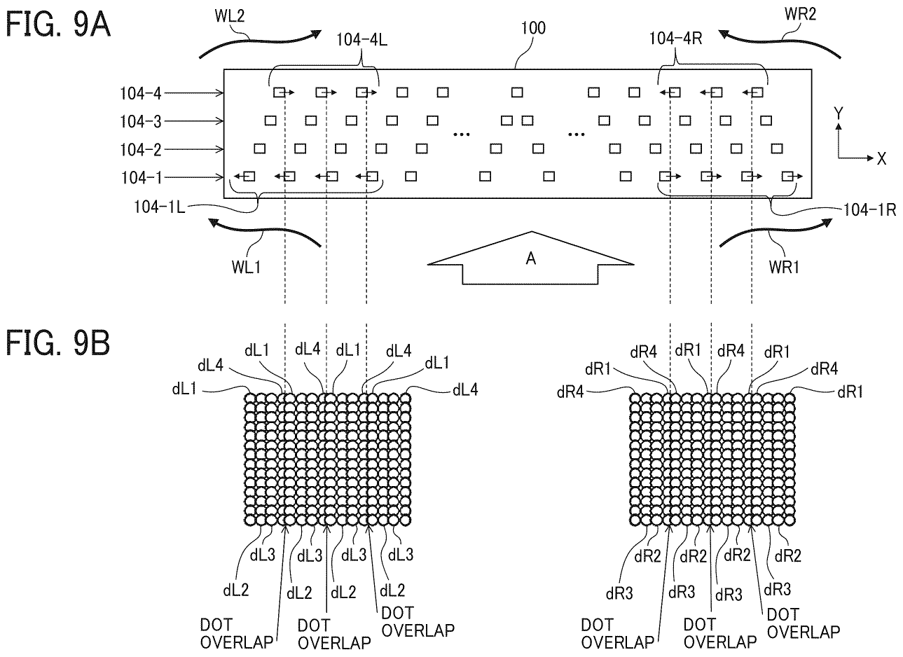

FIG. 9A is an explanatory diagram for describing a configuration of nozzle arrays and wraparound airflows in the liquid discharge head 100 of the present modification, that is, the first modification.

FIG. 9B is an explanatory diagram illustrating dot positions on the continuous sheet 10, to be provided when discharge bending occurs due to wraparound airflows.

In the present modification, that is, the first modification, at least the first nozzle array 104-1 and the fourth nozzle array 104-4 of the four nozzle arrays are configured such that at least the positions of nozzles arranged in both end regions are symmetric with respect to the center in the nozzle array direction. As illustrated in FIG. 9A, the liquid discharge head 100 of the present modification, that is, the first modification is an example in which all the nozzle arrays 104-1 to 104-4 are configured such that the positions of nozzles are symmetric with respect to the center in the nozzle array direction over the entire nozzle arrays.

In other words, in the present modification, that is, the first modification, there is a relationship in which the nozzle shift angle of nozzle arrangement of the four nozzle arrays 104-1 to 104-4 in the left region in the drawing is +θ, and the nozzle shift angle of nozzle arrangement of the four nozzle arrays 104-1 to 104-4 in the right region in the drawing is −θ, as illustrated in FIG. 9A. When the left region in the drawing is taken as an example, the nozzle shift angle referred to herein is an angle formed by the nozzle array direction and a straight line connecting the nozzles 104-1L, 104-2L, 104-3L, 104-4L, and 104-1L corresponding to each of dots dL1, dL2, dL3, dL4, dL1, . . . , in this order, arranged in the nozzle array direction on the continuous sheet 10.

### Second Modification

Next, a description will be given of another modification (the present modification is hereinafter referred to as a “second modification”) of the liquid discharge head according to the above-described embodiment.

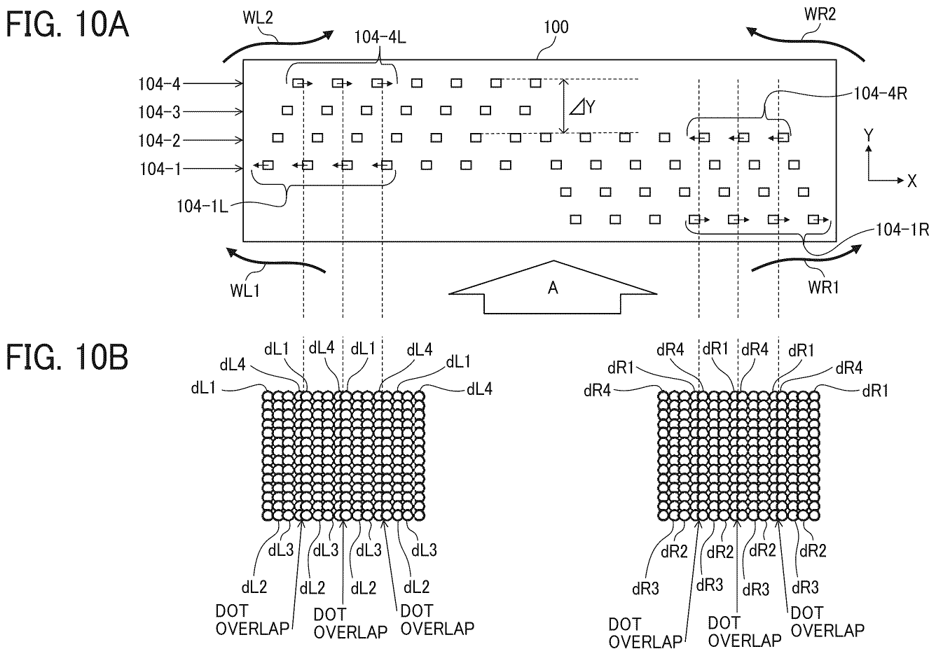

FIG. 10A is an explanatory diagram for describing a configuration of nozzle arrays and wraparound airflows in the liquid discharge head 100 of the present modification, that is, the second modification.

FIG. 10B is an explanatory diagram illustrating dot positions on the continuous sheet 10, to be provided when discharge bending occurs due to the wraparound airflows.

As illustrated in FIG. 10A, in the present modification, that is, the second modification, the four nozzle arrays 104-1 to 104-4 in the right region in the drawing are shifted in the sheet conveyance direction A with respect to the nozzle arrangement of the first modification described above. A disadvantage may be caused in which nozzles are too close to each other and it becomes difficult to form the individual liquid chambers 106 and flow paths, at a switching position where nozzle arrangement in the end region on the left side in the drawing and nozzle arrangement in the end region on the right side in the drawing are switched. In such a case, it is possible to eliminate the disadvantage by adopting a configuration in which the nozzle arrays are shifted in the sheet conveyance direction A, as illustrated in FIG. 10A.

### Third Modification

Next, a description will be given of still another modification (the present modification is hereinafter referred to as a “third modification”) of the liquid discharge head according to the above-described embodiment.

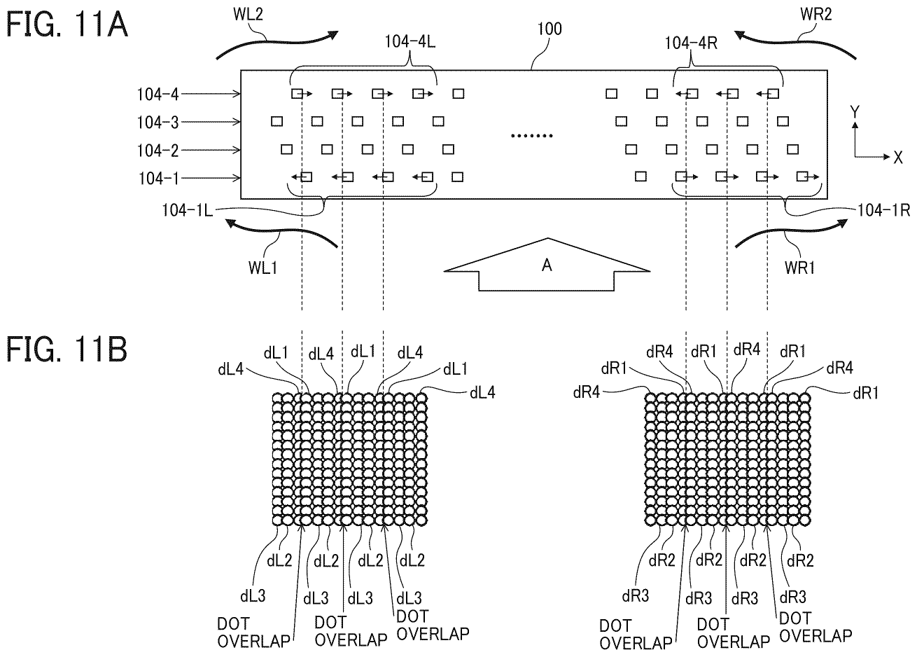

FIG. 11A is an explanatory diagram for describing a configuration of nozzle arrays and wraparound airflows in the liquid discharge head 100 of the present modification, that is, the third modification.

FIG. 11B is an explanatory diagram illustrating dot positions on the continuous sheet 10, to be provided when discharge bending occurs due to the wraparound airflows.

As illustrated in FIG. 11A, the present modification, that is, the third modification is configured such that at least the positions of nozzles arranged in both end regions are symmetric with respect to the center in the nozzle array direction simply for the first nozzle array 104-1 and the fourth nozzle array 104-4 among the four nozzle arrays. That is, among the four nozzle arrays, the positions of nozzles of the second nozzle array 104-2 and the third nozzle array 104-3, which are located neither most downstream nor most upstream in the sheet conveyance direction, are not symmetric with respect to the center in the nozzle array direction.

Since the second nozzle array 104-2 and the third nozzle array 104-3 are located neither most downstream nor most upstream in the sheet conveyance direction, discharge bending is less likely to occur even if the wraparound airflows WR and WL are generated. Therefore, the nozzle arrays 104-2 and 104-3 have the same nozzle arrangement as a normal nozzle array over the entire nozzle array (constant nozzle pitch over the entire nozzle array).

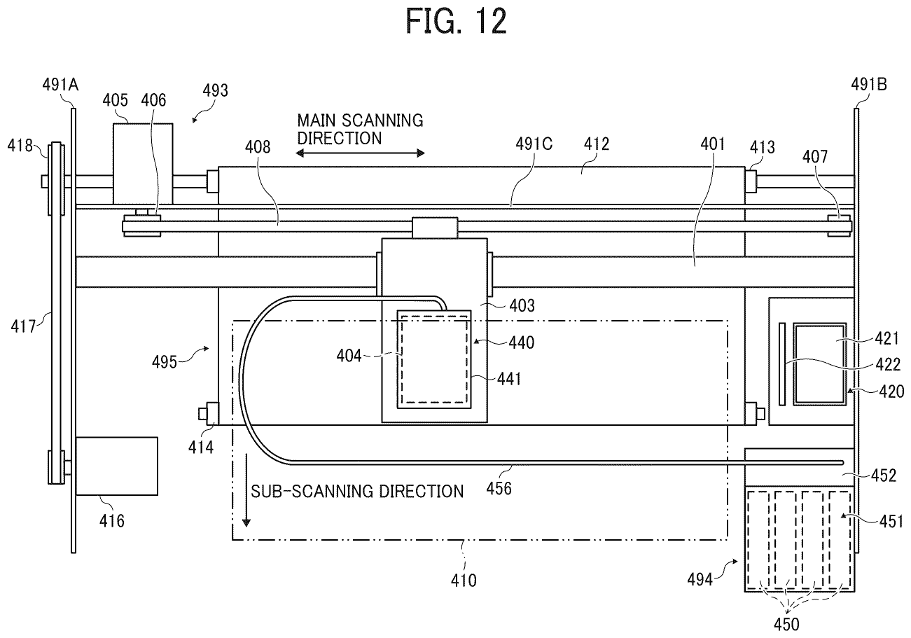

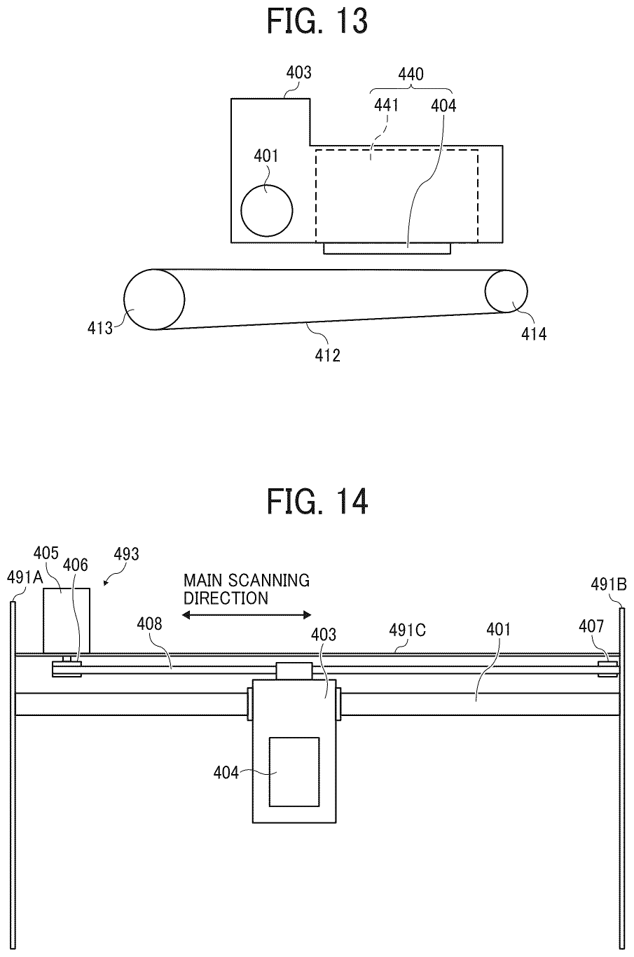

Next, another example of the liquid discharge apparatus according to the present embodiment is described with reference to FIGS. 12 and 13.

FIG. 12 is a plan view of a part of another exemplary liquid discharge apparatus. FIG. 13 is a side view of the part of another exemplary liquid discharge apparatus.

The liquid discharge apparatus is a serial type apparatus, and a main scan moving unit 493 causes a carriage 403 to reciprocate in a main scanning direction MSD. The main scan moving unit 493 includes a guide 401, a main scan motor 405, a timing belt 408, and the like. The guide 401 is bridged between a left-side plate 491A and a right-side plate 491B to moveably hold the carriage 403. The main scan motor 405 causes the carriage 403 to reciprocate in the main scanning direction MSD via the timing belt 408 bridged between a drive pulley 406 and a driven pulley 407.

The carriage 403 carries a liquid discharge unit 440 including a liquid discharge head device 404, which includes the liquid discharge head according to the present embodiment, and a head tank 441 as a single integrated unit. The liquid discharge head device 404 may be referred to simply as “the head device.”

The head device 404 of the liquid discharge unit 440 includes, for example, the liquid discharge heads that discharge liquids of the respective colors of yellow (Y), cyan (C), magenta (M), and black (K), as with the head unit 50 described above. As the liquid discharge heads of the head device 404, the liquid discharge heads 100 each having a nozzle array including multiple nozzles are arrayed in a staggered manner. The multiple nozzles are arrayed in the nozzle array direction, which is a sub scanning direction (head longitudinal direction) orthogonal to the main scanning direction, and the liquid discharge heads discharge liquid downward in a discharge direction, as with the liquid discharge head 100 described above.

A supply unit 494 disposed outside the head device 404 supplies liquid stored in liquid cartridges 450 to the head tank 441 to supply the liquid to the head device 404.

The supply unit 494 includes a cartridge holder 451, a tube 456, a liquid feeder 452 including a liquid feed pump, and the like. The cartridge holder 451 serves as a filling part on which the liquid cartridges 450 are mounted. The liquid cartridge 450 is detachably attached to the cartridge holder 451. The liquid is fed from the liquid cartridge 450 to the head tank 441 by the liquid feeder 452 via the tube 456.

The liquid discharge apparatus includes a conveyor 495 to convey a sheet 410. The conveyor 495 includes a conveyance belt 412 as a conveyor and a sub scan motor 416 to drive the conveyance belt 412.

The conveyance belt 412 attracts the sheet 410 and conveys the sheet 410 to a position facing the head device 404. The conveyance belt 412 is an endless belt looped around a conveyance roller 413 and a tension roller 414. Attraction of the sheet 410 to the conveyance belt 412 may be applied by electrostatic adsorption, air suction, or the like.

The conveyance belt 412 rotates in the sub scanning direction SSD as the conveyance roller 413 is rotationally driven by the sub scan motor 416 via a timing belt 417 and a timing pulley 418.

On one end of the range of movement of the carriage 403 in the main scanning direction, a maintenance unit 420 that maintains the head device 404 in good condition is disposed lateral to the conveyance belt 412.

The maintenance unit 420 includes, for example, a cap 421 to cap the nozzle face (i.e., a face on which nozzles are formed) of the head device 404 and a wiper 422 to wipe the nozzle face.

The main scan moving unit 493, the supply unit 494, the maintenance unit 420, and the conveyor 495 are mounted on a housing that includes the left-side plate 491A, the right-side plate 491B, and a back plate 491C.

In the liquid discharge apparatus thus configured, the sheet 410 is conveyed on and attracted to the conveyance belt 412, and is conveyed in the sub scanning direction SSD by the cyclic rotation of the conveyance belt 412.

The head device 404 is driven in response to an image signal to discharge liquid onto the sheet 410 not in motion while the carriage 403 is moved in the main scanning direction. As a result, an image is formed on the sheet 410.

As described above, the liquid discharge apparatus includes the liquid discharge head according to the present embodiment, thus allowing stable formation of high-quality images.

Next, another example of the liquid discharge unit 440 according to the present embodiment is described with reference to FIG. 14.

FIG. 14 is a plan view of a part of another exemplary liquid discharge unit.

The liquid discharge unit includes the housing, the main scan moving unit 493, the carriage 403, and the head device 404 among the components of the liquid discharge apparatus described above. The left-side plate 491A and the right-side plate 491B, and the back plate 491C form the housing.

The liquid discharge unit 440 may be configured such that at least one of the above-described maintenance unit 420 or the supply unit 494 is further attached to, for example, the right-side plate 491B of the liquid discharge unit 440.

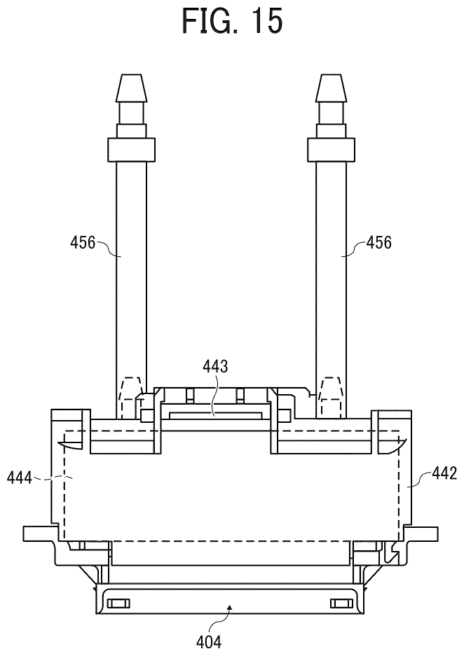

Next, still another example of the liquid discharge unit 440 according to the present embodiment is described with reference to FIG. 15.

FIG. 15 is a front view of still another exemplary liquid discharge unit.

The liquid discharge unit includes the head device 404 to which a channel component 444 is attached, and tubes 456 connected to the channel component 444.

The channel component 444 is disposed inside a cover 442. Alternatively, the liquid discharge unit may include the head tank 441 instead of the channel component 444. A connector 443 for electrically connecting to the head device 404 is disposed on an upper portion of the channel component 444.

In the present disclosure, the “liquid discharge apparatus” includes the liquid discharge head, the liquid discharge head device, or the liquid discharge unit, and drives the liquid discharge head to discharge liquid.

The liquid discharge apparatus may be, for example, an apparatus that can discharge liquid to a material to which liquid can adhere, or an apparatus that discharges liquid toward gas or into liquid.

The “liquid discharge apparatus” may include devices to feed, convey, and eject the material to which liquid can adhere. The “liquid discharge apparatus” may further include a pretreatment apparatus to coat the material with a treatment liquid, and a post-treatment apparatus to coat the material with a treatment liquid, the liquid having been discharged onto the material.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers so as to form a three-dimensional fabrication object.

The “liquid discharge apparatus” is not limited to an apparatus to discharge liquid to visualize meaningful images, such as letters or figures. For example, the “liquid discharge apparatus” may be an apparatus to form meaningless images, such as meaningless patterns, or fabricate three-dimensional images.

The above-described term “material to which liquid can adhere” refers to a material to which liquid can adhere at least temporarily, a material to which liquid adheres and sticks, or a material to be permeated by liquid that adheres thereto. Specific examples of the “material to which liquid can adhere” include, but are not limited to, a medium onto which liquid is discharged (i.e. a discharge target medium) such as a paper sheet, recording paper, a recording sheet of paper, a film, and cloth, electronic components such as an electronic substrate and a piezoelectric element, and media such as a powder layer, an organ model, and a testing cell. The “material to which liquid can adhere” includes any material to which liquid adheres, unless otherwise specified.

Examples of the “material to which liquid can adhere” include any materials to which liquid can adhere even temporarily, such as paper, thread, fiber, fabric, leather, metal, plastic, glass, wood, ceramics, construction materials (e.g., wallpaper and floor material), and textiles for clothing.

Examples of the “liquid” include ink, treatment liquid, DNA samples, resist, pattern material, binder, fabrication liquid, and solution and liquid dispersion containing amino acid, protein, or calcium.

The “liquid discharge apparatus” may be an apparatus in which the liquid discharge head and a material to which liquid can adhere move relative to each other. However, the liquid discharge apparatus is not limited to such an apparatus. For example, the liquid discharge apparatus may be a serial head apparatus that moves the liquid discharge head, or a line head apparatus that does not move the liquid discharge head.

Examples of the “liquid discharge apparatus” further include a treatment liquid coating apparatus to discharge a treatment liquid to a sheet so as to coat a surface of the sheet with the treatment liquid for the purpose of reforming the surface of the sheet, and an injection granulation apparatus in which a composition liquid containing raw materials dispersed in a solution is injected through nozzles to granulate fine particles of the raw materials.

Examples of the “liquid discharge apparatus” according to the present embodiment also include an electrode manufacturing apparatus and an electrochemical element manufacturing apparatus. The electrode manufacturing apparatus is described below.

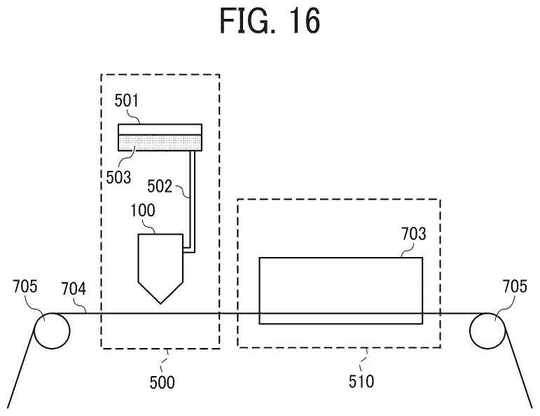

FIG. 16 is a schematic view of an example of the electrode manufacturing apparatus according to the present embodiment.

The electrode manufacturing apparatus is an apparatus for manufacturing an electrode including a layer containing an electrode material by discharging a liquid composition by means of a head module including a liquid discharge head.

A discharge device in the electrode manufacturing apparatus illustrated in FIG. 16 is a head module including the liquid discharge head 100 according to the embodiment (including modifications) described above. The liquid discharge head 100 of the head module discharges a liquid composition. As a result, the liquid composition is applied onto a discharge target medium, and a liquid composition layer is formed on the discharge target medium. The discharge target medium is not limited and may be appropriately selected depending on the intended purpose, as long as the discharge target medium is an object on which a layer containing an electrode material is to be formed.

Examples of the discharge target medium include an electrode substrate (current collector), an active material layer, and a layer containing a solid electrode material. The discharge target medium may be an electrode composite layer containing an active material on an electrode substrate (current collector). The discharge device and a discharge process may be a device and a process for forming a layer containing an electrode material by directly discharging a liquid composition, respectively, as long as the layer containing an electrode material can be formed on the discharge target medium. The discharge device and the discharge process may be a device and a process for forming a layer containing an electrode material by indirectly discharging a liquid composition, respectively.

Other configurations included in the electrode manufacturing apparatus for forming an electrode composite layer are not limited to any particular configuration, and may be appropriately selected depending on the intended purpose. Other processes included in the electrode manufacturing method for forming an electrode composite layer are not limited to any particular process, and may be appropriately selected depending on the intended purpose. For example, a heating device and a heating process are examples of the configuration and the process included in the electrode manufacturing apparatus and method for forming an electrode composite layer, respectively.

The heating device included in the electrode manufacturing apparatus for forming an electrode composite layer is a device that heats the liquid composition discharged by the discharge device. The heating process included in the electrode manufacturing method for forming an electrode composite layer is a process of heating the liquid composition discharged in the discharge process. The liquid composition is heated to dry the liquid composition layer.

An electrode manufacturing apparatus for forming an electrode composite layer containing an active material on an electrode substrate (current collector) is described below as an example of the electrode manufacturing apparatus.

As illustrated in FIG. 16, the electrode manufacturing apparatus includes a discharge process device 500 and a heating process device 510. The discharge process device 500 performs a discharge process of applying a liquid composition onto a print base material 704 having a discharge target medium to form a liquid composition layer. The heating process device 510 performs a heating process of heating the liquid composition layer to obtain an electrode composite layer.

The electrode manufacturing apparatus includes a conveyor 705 that conveys the print base material 704. The conveyor 705 conveys the print base material 704 to the discharge process device 500 and the heating process device 510 in this order at a preset speed. A method for producing the print base material 704 having a discharge target medium such as an active material layer is not limited to any particular method, and a known method can be appropriately selected. The discharge process device 500 includes the liquid discharge head 100 that performs an application process of applying a liquid composition 503 onto the print base material 704, a storage container 501 that stores the liquid composition 503, and a supply tube 502 that supplies the liquid composition 503 stored in the storage container 501 to the liquid discharge head 100.

The discharge process device 500 discharges the liquid composition 503 from the liquid discharge head 100 so that the liquid composition 503 is applied onto the print base material 704 to form a liquid composition layer in a thin film shape. The storage container 501 may be integrated with the electrode manufacturing apparatus for forming an electrode composite layer, or may be detachable from the electrode manufacturing apparatus. The storage container 501 may be a container additionally attachable to a container integrated with the electrode manufacturing apparatus for forming an electrode composite layer or to a container detachable from the electrode manufacturing apparatus for forming an electrode composite layer.

The storage container 501 that stably stores the liquid composition 503 and the supply tube 502 that stably supplies the liquid composition 503 can be used.

The heating process device 510 performs a solvent removal process of heating and removing solvent remaining in the liquid composition layer. Specifically, the solvent that remains in the liquid composition layer is heated and dried by a heater 703 of the heating process device 510. Accordingly, the solvent is removed from the liquid composition layer. Thus, the electrode composite layer is formed. The heating process device 510 may perform the solvent removal process under reduced pressure.

The heater 703 is not particularly limited, and may be appropriately selected depending on the intended purpose.

For example, the heater 703 may be a substrate heater, an infrared (IR) heater, or a hot air heater.

The heater 703 may be a combination of at least two of the substrate heater, the IR heater, and the hot air heater. A heating temperature and heating time can be appropriately selected according to the boiling point of the solvent contained in the liquid composition 503 or the thickness of a formed film.

The electrode manufacturing apparatus according to the present embodiment is used to discharge the liquid composition to a desired position on the discharge target medium. The electrode composite layer can be suitably used as, for example, a part of the configuration of an electrochemical element. The configuration of the electrochemical element other than the electrode composite layer is not particularly limited, and a known configuration can be appropriately selected. For example, as a configuration other than the electrode composite layer, the electrochemical element may include a positive electrode, a negative electrode, and a separator.

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply unit, a maintenance unit, and a main scan moving unit to form a single unit.

Examples of the “single unit” include a combination in which the liquid discharge head and one or more functional parts and units are secured to each other through, e.g., fastening, bonding, or engaging, and a combination in which one of the liquid discharge head and the functional parts and units is movably held by another. The liquid discharge head and the functional part(s) or unit(s) may be detachably attached to each other.

For example, as the liquid discharge unit 440, there is a liquid discharge unit in which the head device 404 and the head tank 441 form a single unit, as in the liquid discharge unit 440 illustrated in FIG. 13. Alternatively, the head and the head tank coupled (connected) with a tube or the like may form the liquid discharge unit as a single unit. A unit including a filter may be added at a position between the head tank and the head of the liquid discharge unit.

In another example, the head and the carriage may form the liquid discharge unit as a single unit.

In still another example, the liquid discharge unit includes the head movably held by a guide that forms part of a main scan moving unit, so that the head and the main scan moving unit form a single unit. Like the liquid discharge unit 440 illustrated in FIG. 14, the head device 404, the carriage 403, and the main scan moving unit 493 may form the liquid discharge unit 440 as a single unit.

In still another example, a cap that forms a part of the maintenance unit may be secured to the carriage on which the head is mounted so that the head, the carriage, and the maintenance unit form a single unit to form the liquid discharge unit.

Like the liquid discharge unit 440 illustrated in FIG. 15, the tube 456 is connected to the head device 404 on which the head tank 441 or the channel component 444 is mounted so that the head device 404 and the supply unit 494 (channel component 444, for example) form a single unit as the liquid discharge unit 440.

The main scan moving unit may be a guide only. The supply unit may be a tube(s) only or a loading unit only.

The actuator element to be used in the “liquid discharge head” is not limited to a particular type of pressure generator. The pressure generator is not limited to the piezoelectric element (or a laminated piezoelectric element) described in the above-described embodiment, and may be, for example, a thermal actuator that employs an electrothermal transducer element, such as a thermal resistor, or an electrostatic actuator including a diaphragm and counter electrodes.

The terms “image formation”, “recording”, “printing”, “image printing”, and “fabricating” used herein may be used synonymously with each other.

According to the present embodiment, it is possible to prevent occurrence of significant image quality degradation in a situation where a wraparound airflow is generated, while high-quality liquid discharge is performed with no or little displacement of dot positions in a situation where no wraparound airflow is generated.

The embodiment and modifications described above are presented as examples, and are not intended to limit the scope of the present disclosure. The above-described novel embodiment and modifications can be implemented in other various forms, and various omissions, replacements, and changes can be made without departing from the scope of the present disclosure. The embodiment and modifications or variations thereof are included in the scope and gist of the present disclosure, and are included in the scope of claims and the equivalent scope thereof.

The above-described embodiment and modifications are limited examples, and the present disclosure includes, for example, the following aspects having advantageous effects.

### Aspect 1

According to Aspect 1, a liquid discharge head 100 includes multiple nozzle arrays 104-1 to 104-4 extending in a nozzle array direction orthogonal to a discharge target medium conveyance direction (for example, a sheet conveyance direction A) that is a direction in which a discharge target medium (for example, a continuous sheet 10) is conveyed. In the liquid discharge head 100, nozzles 104-1R and 104-1L arranged in both end regions of an upstream nozzle array (for example, a first nozzle array 104-1) located on an upstream side in the discharge target medium conveyance direction and nozzles 104-4R and 104-4L arranged in both end regions of a downstream nozzle array (for example, a fourth nozzle array 104-4) located on a downstream side in the discharge target medium conveyance direction are disposed in such a way as to correspond to dots dL1, dL4, dR1, and dR4 adjacent to each other on the discharge target medium, and in either of both the end regions, the dots dL1 and dR1 corresponding to nozzles of the upstream nozzle array are located adjacent to dots dL4 and dR4 corresponding to nozzles of the downstream nozzle array such that the dots dL1 and dR1 are located closer to a nozzle array direction central region than the dots dL4 and dR4.

In a general liquid discharge head, when no discharge bending is caused by a wraparound airflow, a dot pitch (distance between dots in the nozzle array direction on the discharge target medium) formed by liquid discharged from the nozzles of the upstream nozzle array and the nozzles of the downstream nozzle array becomes a target pitch. However, when an airflow is generated by conveyance of the discharge target medium, the airflow goes around to the left and right of the nozzle face (outer sides of the nozzle face in the nozzle array direction) due to the effect of an air curtain brought about by liquid discharge in the discharge region. Due to the wraparound airflows, liquid discharged from nozzles arranged in each end region of the upstream nozzle array located on the upstream side in the discharge target medium conveyance direction is bent from the center toward a corresponding end in the nozzle array direction. Furthermore, the wraparound airflows after wrapping around the outer sides of the nozzle face in the nozzle array direction flow in such a way as to enter the downstream side of the nozzle face in the discharge target medium conveyance direction. Therefore, liquid discharged from nozzles arranged in each end region of the downstream nozzle array located on the downstream side in the discharge target medium conveyance direction is bent by the wraparound airflows from a corresponding end toward the center in the nozzle array direction. As described above, liquid discharged from the nozzles arranged in both the end regions of the upstream nozzle array is bent by the wraparound airflows in a direction opposite to a direction in which liquid discharged from the nozzles arranged in both the end regions of the downstream nozzle array is bent by the wraparound airflows.

Here, the nozzles arranged in both the end regions of the upstream nozzle array and the nozzles arranged in both the end regions of the downstream nozzle array may be disposed in such a way as to correspond to dots adjacent to each other on the discharge target medium. In the case of such a configuration, image quality may be significantly deteriorated as a result of displacement of dot positions on the discharge target medium due to the discharge bending caused by the wraparound airflows. Specifically, in such a configuration, when liquid is bent by the wraparound airflows in a direction in which dots approach each other between the upstream nozzle array and the downstream nozzle array, image quality degradation may occur in which image density becomes higher than desired density due to overlapping of adjacent dots. In contrast, when discharged liquid is bent in a direction in which the dots are separated from each other between the upstream nozzle array and the downstream nozzle array due to the wraparound airflows, image quality degradation may occur in which dot vacancy (void in the image) is caused by separation of adjacent dots. Among these types of image quality degradation, the former (image quality degradation in which image density increases) is a minor image quality degradation that barely matters, but the latter, that is, dot vacancy (void in the image), is a major problem that needs to be eliminated, and is significant image quality degradation.

The liquid discharge head having the configuration described above is generally configured such that each nozzle position of the upstream nozzle array is shifted to one end side in the nozzle array direction with respect to each nozzle position of the downstream nozzle array over the entire nozzle array. Therefore, when the wraparound airflows are generated, liquid is bent in the direction in which dots approach each other between the upstream nozzle array and the downstream nozzle array in one of the end regions, but liquid is bent in the direction in which dots are separated from each other between the upstream nozzle array and the downstream nozzle array in the other end region. As a result, in either one of both the end regions, significant image quality degradation occurs in which dot vacancy (void in the image) is caused by the wraparound airflows.

In this aspect, in either of both the end regions, dots corresponding to nozzles of the upstream nozzle array are located adjacent to dots corresponding to nozzles of the downstream nozzle array such that the dots corresponding to the nozzles of the upstream nozzle array are located closer to a nozzle array direction central region than the dots corresponding to the nozzles of the downstream nozzle array. With this configuration, discharged liquid is bent by the wraparound airflows in a direction in which the dots approach each other between the upstream nozzle array and the downstream nozzle array in either end region. Therefore, in either end region, there is no significant image quality degradation of dot vacancy (void in the image) due to the bending of liquid in a direction in which the dots are separated from each other between the upstream nozzle array and the downstream nozzle array.

In the present aspect, when wraparound airflows are generated, image quality degradation in which image density is increased due to discharge bending may occur in both the end regions. However, this image quality degradation is minor image quality degradation as described above, and barely matters.

A liquid discharge head (100) includes: multiple nozzle arrays (104-1 to 104-4) including multiple nozzles arrayed in a nozzle array direction (X), the multiple nozzles configured to discharge liquid, in a discharge direction orthogonal to the nozzle array direction (X), onto a medium conveyed in a conveyance direction (Y) orthogonal to the nozzle array direction (X) and the discharge direction, the multiple nozzle arrays (104-1 to 104-4) arrayed in the conveyance direction (Y) and having: end regions at both ends of the multiple nozzle arrays (104-1 to 104-4); and a central region between the end regions. The multiple nozzle arrays (104-1 to 104-4) includes: upstream nozzle array (104-1, 104-2) on an upstream side in the conveyance direction (Y); and downstream nozzle array (104-3, 104-4) on a downstream side in the conveyance direction, the upstream nozzle array (104-1, 104-2) includes a first nozzle in one of the end regions of the upstream nozzle array (104-1, 104-2) in the nozzle array direction (X), the downstream nozzle array (104-3, 104-4) includes a second nozzle in one of the end regions of the downstream nozzle array (104-3, 104-4) in the nozzle array direction (X), the first nozzle is adjacent to the second nozzle in the nozzle array direction (X), and the first nozzle is: shifted from the second nozzle in the nozzle array direction (X); and disposed closer to the central region than the second nozzle in the nozzle array direction (X).

The upstream nozzle array (104-1, 104-2) includes a third nozzle in another of the end regions of the upstream nozzle array (104-1, 104-2) in the nozzle array direction (X), the downstream nozzle array (104-3, 104-4) includes a fourth nozzle in another of the end regions of the downstream nozzle array (104-3, 104-4) in the nozzle array direction (X), the third nozzle is adjacent to the fourth nozzle in the nozzle array direction, and the third nozzle is: shifted from the fourth nozzle in the nozzle array direction (X); and disposed closer to the central region than the fourth nozzle in the nozzle array direction.

The upstream nozzle array (104-1) is at the most upstream of the multiple nozzle arrays (104-1 to 104-4) in the conveyance direction (X). The downstream nozzle array (104-4) is disposed at the most downstream of the multiple nozzle arrays (104-1 to 104-4) in the conveyance direction (X). The upstream nozzle array (104-1) is disposed at the most upstream of the multiple nozzle arrays (104-1 to 104-4) in the conveyance direction (X), and the downstream nozzle array (104-4) is disposed at the most downstream of the multiple nozzle arrays (104-1 to 104-4) in the conveyance direction (X). The multiple nozzle arrays (104-1 to 104-4) includes one or more nozzle arrays between the upstream nozzle array and the downstream nozzle array in the conveyance direction.

The first nozzle is shifted from the second nozzle in a first direction in the nozzle array direction (X), the third nozzle is shifted from the fourth nozzle in a second direction opposite to the first direction in the nozzle array direction (X), and the first nozzle is shifted from the second nozzle in the second direction in the nozzle array direction (X) at a switching position closer to either one of the end regions than the central region in the nozzle array direction. The first nozzle is shifted from the second nozzle in a first direction in the nozzle array direction (X), the third nozzle is shifted from the fourth nozzle in a second direction opposite to the first direction in the nozzle array direction (X), and the first nozzle is shifted from the second nozzle in the second direction in the nozzle array direction (X) at a switching position closer to the central region than the end regions in the nozzle array direction.

The multiple nozzle arrays has the multiple nozzles symmetrically arranged with respect to the switching position at a center of the multiple nozzle arrays in the nozzle array direction. A liquid discharge unit (440) includes the liquid discharge head (100). A liquid discharge apparatus includes the liquid discharge head (100).

The upstream nozzle array (104-1) is disposed at the most upstream of the multiple nozzle arrays (104-1 to 104-4) in the conveyance direction (X), the downstream nozzle array (104-4) is disposed at the most downstream of the multiple nozzle arrays (104-1 to 104-4) in the conveyance direction (X), the upstream nozzle array (104-1) in the one of the end region is shifted from the upstream nozzle array (104-1) in the another of the end regions in the conveyance direction (Y), and the downstream nozzle array (104-4) in the one of the end region is shifted from the downstream nozzle array (104-4) at the another of the end regions in the conveyance direction (Y). The upstream nozzle array and the downstream nozzle array have the multiple nozzles symmetrically arranged with respect a center of the multiple nozzle arrays in the nozzle array direction, and the one or more nozzle arrays (104-2 to 104-3) have the multiple nozzles not symmetrically arranged with respect the center of the multiple nozzle arrays in the nozzle array direction.

As described above, in the present aspect, even if wraparound airflows are generated, no significant image quality degradation occurs. Thus, it is not necessary to adopt a configuration such as the configuration of the conventional liquid discharge head in which a nozzle pitch is changed from an original nozzle pitch in advance by an amount by which liquid is to be bent by the wraparound airflows.

Therefore, according to the present aspect, it is possible to arrange nozzles in such a way as to perform high-quality liquid discharge with no or little displacement of dot positions in a situation where no wraparound airflow is generated, and to prevent occurrence of significant image quality degradation even in a situation where a wraparound airflow is generated.

### Aspect 2

According to Aspect 2, in the liquid discharge head of Aspect 1, the upstream nozzle array includes a most-upstream nozzle array (for example, the first nozzle array 104-1) located on a most-upstream side in the discharge target medium conveyance direction.

Compared to second and subsequent nozzle arrays from the upstream side in the discharge target medium conveyance direction, the most-upstream nozzle array is apt to cause discharge bending due to wraparound airflows, and is apt to cause the significant image quality degradation of dot vacancy (void in the image). Therefore, such significant image quality degradation can be effectively prevented.

### Aspect 3

According to Aspect 3, in the liquid discharge head of Aspect 1, the downstream nozzle array includes a most-downstream nozzle array (for example, the fourth nozzle array 104-4) located on a most-downstream side in the discharge target medium conveyance direction.

Compared to second and subsequent nozzle arrays from the downstream side in the discharge target medium conveyance direction, the most-downstream nozzle array is apt to cause discharge bending due to wraparound airflows, and is apt to cause the significant image quality degradation of dot vacancy (void in the image). Therefore, such significant image quality degradation can be effectively prevented.

### Aspect 4

According to Aspect 4, in the liquid discharge head of Aspect 1, the upstream nozzle array is a most-upstream nozzle array (for example, the first nozzle array 104-1) located on a most-upstream side in the discharge target medium conveyance direction, and the downstream nozzle array is a most-downstream nozzle array (for example, the fourth nozzle array 104-4) located on a most-downstream side in the discharge target medium conveyance direction.

The most significant image quality degradation to be caused between the most-upstream nozzle array and the most-downstream nozzle array is dot vacancy (void in the image) due to discharge bending caused by wraparound airflows. Therefore, the most significant image quality degradation can be effectively prevented.

### Aspect 5

According to Aspect 5, in the liquid discharge head of Aspect 4, one or more nozzle arrays are provided between the upstream nozzle array and the downstream nozzle array.

This allows the liquid discharge head that performs liquid discharge with high dot density to prevent occurrence of significant image quality degradation in a situation where a wraparound airflow is generated, while high-quality liquid discharge is performed with no or little displacement of dot positions in a situation where no wraparound airflow is generated.

### Aspect 6

According to Aspect 6, in the liquid discharge head of any one of Aspects 1 to 5, the nozzles of the upstream nozzle array and the nozzles of the downstream nozzle array correspond to dots adjacent to each other on the discharge target medium over an entire region in the nozzle array direction, and a switching position on each of the upstream nozzle array and the downstream nozzle array is located closer to either one of end sides in the nozzle array direction, a dot positional relationship between nozzles of the upstream nozzle array and nozzles of the downstream nozzle array in one of both the end regions and a dot positional relationship between nozzles of the upstream nozzle array and nozzles of the downstream nozzle array in another of both the end regions being switched at the switching position.

According to this aspect, the dot positional relationship just needs to be coped with simply for an end region where discharge bending is likely to occur due to wraparound airflows, and it is possible to avoid a significant change from the existing nozzle arrangement.

### Aspect 7

According to Aspect 7, in the liquid discharge head of any one of Aspects 1 to 5, the nozzles of the upstream nozzle array and the nozzles of the downstream nozzle array correspond to dots adjacent to each other on the discharge target medium over an entire region in the nozzle array direction, and a switching position on each of the upstream nozzle array and the downstream nozzle array is located at a central position in the nozzle array direction, a dot positional relationship between nozzles of the upstream nozzle array and nozzles of the downstream nozzle array in one of both the end regions and a dot positional relationship between nozzles of the upstream nozzle array and nozzles of the downstream nozzle array in another of both the end regions being switched at the switching position.

According to this aspect, even in a liquid discharge head having a short nozzle array, or a liquid discharge head to be significantly affected by wraparound airflows, it is possible to prevent occurrence of significant image quality degradation such as dot vacancy (void in the image).

### Aspect 8

According to Aspect 8, in the liquid discharge head of any one of Aspects 1 to 7, the upstream nozzle array and the downstream nozzle array are disposed such that at least positions of nozzles arranged in both the end regions are symmetric with respect to a center in the nozzle array direction.

This makes it possible to reduce the difference in dot quality (image quality) between both end regions in the nozzle array direction.

### Aspect 9

According to Aspect 9, a liquid discharge unit includes the liquid discharge head of any one of Aspects 1 to 8.

According to this aspect, it is possible to provide a liquid discharge unit that can prevent occurrence of significant image quality degradation in a situation where a wraparound airflow is generated, while high-quality liquid discharge is performed with no or little displacement of dot positions in a situation where no wraparound airflow is generated.

### Aspect 10

According to Aspect 10, a liquid discharge apparatus includes the liquid discharge head of any one of Aspects 1 to 8, or the liquid discharge unit of Aspect 9.

According to this aspect, it is possible to provide a liquid discharge apparatus that can prevent occurrence of significant image quality degradation in a situation where a wraparound airflow is generated, while high-quality liquid discharge is performed with no or little displacement of dot positions in a situation where no wraparound airflow is generated.

1. A liquid discharge head comprising:
multiple nozzle arrays including multiple nozzles arrayed in a nozzle array direction,
the multiple nozzles configured to discharge liquid, in a discharge direction orthogonal to the nozzle array direction, onto a medium conveyed in a conveyance direction orthogonal to the nozzle array direction and the discharge direction,
the multiple nozzle arrays arrayed in the conveyance direction and having:
end regions at both ends of the multiple nozzle arrays; and
a central region between the end regions,
wherein the multiple nozzle arrays includes:
upstream nozzle array on an upstream side in the conveyance direction; and
downstream nozzle array on a downstream side in the conveyance direction,
the upstream nozzle array includes a first nozzle in one of the end regions of the upstream nozzle array in the nozzle array direction,
the downstream nozzle array includes a second nozzle in one of the end regions of the downstream nozzle array in the nozzle array direction,
the first nozzle is adjacent to the second nozzle in the nozzle array direction, and
the first nozzle is:
shifted from the second nozzle in the nozzle array direction; and
disposed closer to the central region than the second nozzle in the nozzle array direction.

2. The liquid discharge head according to claim 1,
wherein the upstream nozzle array includes a third nozzle in another of the end regions of the upstream nozzle array in the nozzle array direction,
the downstream nozzle array includes a fourth nozzle in another of the end regions of the downstream nozzle array in the nozzle array direction,
the third nozzle is adjacent to the fourth nozzle in the nozzle array direction, and
the third nozzle is:
shifted from the fourth nozzle in the nozzle array direction; and
disposed closer to the central region than the fourth nozzle in the nozzle array direction.

3. The liquid discharge head according to claim 1,
wherein the upstream nozzle array is at the most upstream of the multiple nozzle arrays in the conveyance direction.

4. The liquid discharge head according to claim 1,
wherein the downstream nozzle array is disposed at the most downstream of the multiple nozzle arrays in the conveyance direction.

5. The liquid discharge head according to claim 1,
wherein the upstream nozzle array is disposed at the most upstream of the multiple nozzle arrays in the conveyance direction, and
wherein the downstream nozzle array is disposed at the most downstream of the multiple nozzle arrays in the conveyance direction.

6. The liquid discharge head according to claim 5,
wherein the multiple nozzle arrays includes one or more nozzle arrays between the upstream nozzle array and the downstream nozzle array in the conveyance direction.

7. The liquid discharge head according to claim 2,
wherein the first nozzle is shifted from the second nozzle in a first direction in the nozzle array direction,
the third nozzle is shifted from the fourth nozzle in a second direction opposite to the first direction in the nozzle array direction, and
the first nozzle is shifted from the second nozzle in the second direction in the nozzle array direction at a switching position closer to either one of the end regions than the central region in the nozzle array direction.

8. The liquid discharge head according to claim 2,
wherein the first nozzle is shifted from the second nozzle in a first direction in the nozzle array direction,
the third nozzle is shifted from the fourth nozzle in a second direction opposite to the first direction in the nozzle array direction, and
the first nozzle is shifted from the second nozzle in the second direction in the nozzle array direction at a switching position closer to the central region than the end regions in the nozzle array direction.

9. The liquid discharge head according to claim 8,
wherein the multiple nozzle arrays has the multiple nozzles symmetrically arranged with respect to the switching position at a center of the multiple nozzle arrays in the nozzle array direction.

10. A liquid discharge unit comprising the liquid discharge head according to claim 1.

11. A liquid discharge apparatus comprising the liquid discharge head according to claim 1.

12. The liquid discharge head according to claim 2,
wherein the upstream nozzle array is disposed at the most upstream of the multiple nozzle arrays in the conveyance direction,
the downstream nozzle array is disposed at the most downstream of the multiple nozzle arrays in the conveyance direction,
the upstream nozzle array in the one of the end region is shifted from the upstream nozzle array in the another of the end regions in the conveyance direction, and
the downstream nozzle array in the one of the end region is shifted from the downstream nozzle array at the another of the end regions in the conveyance direction.

13. The liquid discharge head according to claim 6,
wherein the upstream nozzle array and the downstream nozzle array have the multiple nozzles symmetrically arranged with respect a center of the multiple nozzle arrays in the nozzle array direction, and
the one or more nozzle arrays have the multiple nozzles not symmetrically arranged with respect the center of the multiple nozzle arrays in the nozzle array direction.
